(19) United States
(12) Patent Application Publication
(10) Pub. No.: US 2026/0059355 A1
(43) Pub. Date: Feb. 26, 2026

(54) METHOD FOR EVALUATING DOWNLINK CHARACTERISTICS

(71) Applicant: Rohde & Schwarz GmbH & Co. KG, Muenchen (DE)

(72) Inventors: Francesco ROSSETTO, Muenchen (DE); Andreas OELDEMANN, Muenchen (DE); Niels PETROVIC, Muenchen (DE)

(21) Appl. No.: 18/811,852

(22) Filed: Aug. 22, 2024

(51) Int. Cl. H04W 24/06

(52) U.S. Cl. CPC H04W 24/06

(57) ABSTRACT

A method for evaluating downlink characteristics is described, wherein a network is provided by a radio communication tester for testing a device under test. The network provided is an emulated cellular network. The radio communication tester connects with the device under test via the network, thereby establishing a downlink channel for the device under test. At least one channel state information of the downlink channel is determined while testing the device under test, wherein the channel state information is determined without usage of a feedback from the device under test.

### FIELD OF THE DISCLOSURE

The present disclosure relates to a method for evaluating downlink characteristics, in a setting where a radio communication tester connects with a device under test via a network and thereby establishes a downlink channel for the device under test.

### BACKGROUND

In radio communication testing, it is desirable to evaluate properties of a downlink (DL) channel used by a radio communication tester communicating with a device under test (DUT). The DUT is for example a user equipment (UE) like a mobile, a smartphone or a tablet. Typically, the properties of the channel are referred to as channel state information (CSI). The properties of the channel, namely the CSI, may be processed further by the radio communication tester so as to obtain a CSI metric, e.g. a Generalized Squared Cosine Similarity (GSCS) metric, which can be evaluated for obtaining information about the DUT.

Generally, the DUT may be requested to provide its CSI estimation to the radio communication tester. Then, the radio communication tester might evaluate how good the estimate was in comparison with the actual channel for the GSCS metric. However, providing the CSI estimation requires communication of the DUT with the radio communication tester over a side channel. A side channel either uses up radio resources or a (physical) transmission line has to be provided. Moreover, the reporting of CSI by the DUT has high bandwidth requirements and can introduce delays regarding the availability of the CSI at the radio communication tester.

Accordingly, there is a need for a method for evaluating downlink characteristics that is capable of obtaining CSI in a timely and efficient manner.

### SUMMARY

The following summary of the present disclosure is intended to introduce different concepts in a simplified form that are described in further detail in the detailed description provided below. This summary is neither intended to denote essential features of the present disclosure nor shall this summary be used as an aid in determining the scope of the claimed subject matter.

The present disclosure provides examples of a method for evaluating downlink characteristics. A network, such as an emulated cellular network, is provided by a radio communication tester for testing a device under test (DUT). In an embodiment, the radio communication tester connects with the device under test via the network, thereby establishing a downlink channel for the device under test. At least one channel state information of the downlink channel is determined while testing the device under test, wherein the channel state information (CSI) is determined without usage of feedback from the device under test.

Accordingly, CSI can be obtained in a timely and efficient manner, as no intervention of the DUT is required. The need for using radio resources for reporting CSI by the DUT can be eliminated accordingly. In a certain embodiment, a side channel for communication of the DUT with the radio communication tester can be omitted. Moreover, latency regarding the availability of the CSI at the radio communication tester can be mitigated.

Generally, the radio communication tester may also be called a system simulator (SS), as the radio communication tester simulates/emulates the cellular network for testing the DUT.

In an embodiment, the CSI may be determined by the radio communication tester, e.g. at SS side, namely at side of the radio communication tester.

According to an aspect, a signal chain, for example, may be established between the radio communication tester and the device under test. Parameters of components involved in the signal chain may be used for determining the channel state information. Therefore, any influence on the downlink channel by the components involved in the signal chain can be taken into consideration by the radio communication tester for determining the CSI. The respective components involved may either forward information to the radio communication tester and/or the influence of the components was determined previously, for instance by a calibration step.

For example, the components involved in the signal chain may comprise a front end of the radio communication tester, a transmission channel between the radio communication tester and the device under test, and a front end of the device under test. The transmission channel can be e.g. a radio channel or a transmission line. Accordingly, the communication may be done over-the-air, OTA, or in a wired manner. Hence, an OTA channel or a wire-based channel may be provided, the influence of which can be measured as well. In the conducted case, namely in case of the wire-based channel, the information is equivalent to an offline measurement of the cable used. For the OTA channel, a calibration of the OTA environment is required which is challenging, but feasible.

In an embodiment, the respective front ends may relate to analog front ends.

Hence, information about the influence of the front end of the radio communication tester may be obtained during production of the radio communication tester and/or during its maintenance. The information may be stored such that it can be accessed for determining the CSI by the radio communication tester.

In an embodiment, information about the influence of the front end of the device under test, namely the influence from an antenna of the DUT to an internal ADC of the DUT, may be provided by the manufacturer of the device under test or determined previously. Consequently, the information about the influence of the front end of the device under test is available and can be used by the radio communication tester for determining the CSI.

In an embodiment, the components involved in the signal chain may also comprise a digital fader of the radio communication tester. The digital fader is, for example, a fading simulator. The digital fader may be used by the radio communication tester for simulating/emulating the cellular network to which the device under test is connected, thereby ensuring realistic testing of the device under test, as the strength of the connection may be varied accordingly.

In an embodiment, the communication between the radio communication tester and the device under test may take place in an analog manner, namely via an OTA connection or a wire-based connection, or in a digital manner, namely via a digital baseband connection, e.g. via an IQ channel.

Emulation parameters of the radio communication tester may be used for determining the channel state information. The emulation parameters are used by the radio communication tester for emulating the cellular network to which the device under test is connected, thereby defining the downlink for the device under test. These emulation parameters are inter alia used for determining the channel state information, as the emulation parameters define the downlink for the device under test.

For example, the emulation parameters may comprise fading parameters used by the digital fader of the radio communication tester, namely for emulating the cellular network to which the device under test is connected. As discussed above, the fading parameters are used for providing a realistic downlink when testing the device under test.

According to one aspect, the radio communication tester and the device under test, for example, may communicate directly in a baseband during the testing. As indicated above, the respective communication may take place in a digital manner. Hence, the analog part is bypassed and the baseband signal processing and signaling can be tested. Any influence of analog components like the analog front ends do not have to be considered when the radio communication tester and the device under test communicate directly in the baseband.

According to another aspect, front end parameters and transmission channel parameters, for example, were determined previously. In an embodiment, the front end parameters and the transmission channel parameters may be used for determining the channel state information. In an embodiment, the front end parameters concern a radio frequency (RF) front end of the radio communication tester and an RF front end of the DUT, respectively. In an embodiment, the transmission channel parameters concern a radio channel or a transmission line provided between the RF front end of the radio communication tester and the RF front end of the device under test. The front ends may relate to RF front ends so that the communication between the radio communication tester and the device under test relates to an RF communication. The RF communication may be provided by an over-the-air (OTA) connection or by a cable connection, as outlined above. The respective OTA environment or the cable providing the wired connection may be measured previously so that the respective influence on the CSI can be taken into account as well.

In an embodiment, the channel state information may be determined by forming a convolution that uses the emulation parameters, the front end parameters, and the transmission channel parameters. Accordingly, the CSI takes parameters of all components involved in the signal chain into account, namely the components used for emulation, which are associated with the emulation parameters, as well as the components used for transmission, which are associated with the front end parameters and the transmission channel parameters.

Generally, the emulation parameters relate to a digital baseband part, whereas the front end parameters and the transmission channel parameters relate to analog parts, respectively. The analog parts, namely the front end parameters and the transmission channel parameters, may be determined offline, whereas the digital baseband part, namely the emulation parameters, is evaluated in real-time, namely at runtime.

At least one of the front end parameters of the RF front end of the radio communication tester, the front end parameters of the RF front end of the device under test, or the transmission channel parameters were measured with a measurement instrument distinct from the radio communication tester. Accordingly, information with regard to the influence of the respective component, namely the RF front end of the radio communication tester, the RF front end of the device under test and/or the transmission channel, e.g. the OTA environment or the cable used, are obtained previously. The respective information may be stored and accessed by the radio communication tester for determining the CSI.

For example, the front end parameters of the RF front end of the device under test were measured previously by a customer or an application engineer at a customer site. Hence, it can be ensured that the information can be gathered by each customer.

Alternatively, the manufacturer of the device under test provides the front end parameters of the device under test, for example the front end parameters of the RF front end of the device under test.

In an embodiment, the information gathered, e.g. by the customer, the application engineer, or the manufacturer, can be used by the radio communication tester for determining the CSI.

In an embodiment, the front end parameters of the RF front end of the device under test may be based on a reference signal received power, RSRP, report. The RSRP report may be provided by the device under test during an initial calibration. The RSRP report may be provided for each receiver branch of the device under test or comprise information for each receiver branch of the device under test.

In an embodiment, the reference signal received power report may comprise information about a reference signal received power per branch concerning the radio communication tester, also called simulation system reference signal received power per branch (SS-RSRPB), as well as a reference signal antenna relative phase concerning the radio communication tester, also called simulation system reference signal antenna relative phase (SS-RSARP).

The SS reference signal received power per branch (SS-RSRPB) is defined as the linear average over the power contributions of the resource elements that carry secondary synchronization signals.

The SS reference signal antenna relative phase (SS-RSARP) is defined as the difference of the average phase of the receive signals on the resource elements that carry secondary synchronization signals received by the reference individual receiver branch and the average phase of the receive signals on the resource elements that carry secondary synchronization signals received by one other individual receiver branch.

Varying fading parameters may be considered for determining the channel state information. The fading parameters (or fading coefficients) are used when emulating the cellular network. These fading parameters/coefficients used for emulation purposes is also taken into account when determining the channel state information by the radio communication tester.

According to another aspect, additional calibration parameters, for example, may be used for determining the channel state information. In an embodiment, the calibration parameters may be obtained by performing a calibration before the testing of the device under test. In an embodiment, the calibration parameters concern a composition comprising a radio frequency, (RF) front end of the radio communication tester and an RF front end of the device under test, respectively, as well as a radio channel or a transmission line provided between the RF front end of the radio communication tester and the RF front end of the device under test. In an embodiment, an initial calibration is done. At least one calibration signal is provided by the radio communication tester, e.g. its baseband circuit, wherein the at least one calibration signal is processed by the digital fader and the front end of the radio communication tester. Then, the at least one calibration signal is transmitted via the channel established between the radio communication tester and the device under test before being received by the front end of the device under test, which forwards the at least one calibration signal to a baseband circuit of the device under test. The device under test reports back measured values to the radio communication tester, which comprise information used for determining the channel state information by the radio communication tester afterwards.

In an embodiment, the calibration may comprise transmitting a calibration sequence from the radio communication tester to the device under test via the radio channel or transmission line, and transmitting a response to the calibration sequence from the device under test to the radio communication tester. The calibration sequence comprises the processing of the at least one calibration signal, as indicated above. The calibration sequence however may also comprise several calibration signals processed subsequently.

In an embodiment, an RF front end of the radio communication tester, an RF front end of the device under test, as well as a transmission channel provided between the RF front end of the radio communication tester and the RF front end of the device under test may maintain constant properties during the testing. In this case, only one measurement is required for these components since the information regarding the influence of these components maintains constant. Hence, the efforts required can be reduced significantly.

In an embodiment, the channel state information may be determined for example by an electronic circuit of the radio communication tester. The electronic circuit may relate to an evaluation and/or analysis circuit that is enabled to process information gathered. The electronic circuit may be enabled to access a storage medium on which information of components of the signal chain is stored, which have an influence on the downlink characteristics.

Additionally or alternatively, the channel state information may be determined by a cloud computing circuit that is separately formed with respect to the radio communication tester. Therefore, the evaluation and/or analysis may be outsourced to a remote computing circuit, for example a computing circuit having more computational power than the radio communication tester. The cloud computing circuit may also take further information into account that is not available to the local radio communication tester.

In an embodiment, the determined channel state information may be compared with reported channel state information that was obtained from the device under test. Hence, a quality of the reported (e.g. estimated) channel state information can be evaluated.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIG. 1 is a block diagram schematically illustrating an example of a network provided by a radio communication tester as well as a method used in the state of the art;

FIG. 2 is a block diagram schematically illustrating an example embodiment of a method for evaluating downlink characteristics according to an aspect of the present disclosure;

FIG. 3 is a block diagram schematically illustrating an example embodiment method for evaluating downlink characteristics according to another aspect of the present disclosure; and

FIG. 4 is a block diagram schematically illustrating an example embodiment method for evaluating downlink characteristics according to yet another aspect of the present disclosure.

### DETAILED DESCRIPTION

The detailed description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

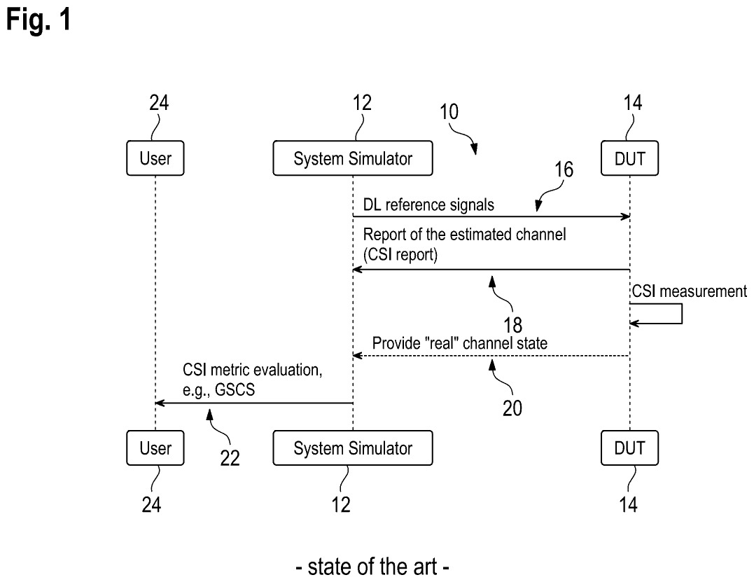

FIG. 1 is a block diagram schematically illustrating a network 10 provided by a radio communication tester 12. The network 10 is provided by the radio communication tester 12 for testing a device under test (DUT) 14. The network 10 provided is an emulated cellular network. For example, the radio communication tester 12 may act as a system simulator or, more specifically, as a base station simulator. The DUT 14 is, for example, a user equipment (UE), e.g. a mobile, a smartphone or a tablet.

The radio communication tester 12 connects with the DUT 14 via the network 10, thereby establishing a downlink channel for the DUT 14. In the depicted example of FIG. 1, downlink reference signals 16 are sent from the radio communication tester 12 to the DUT 14 via the downlink channel.

The present disclosure provides examples of a method for evaluating downlink characteristics, namely the characteristics of the downlink channel. At least one channel state information (CSI) of the downlink channel is determined while testing the DUT 14, wherein the channel state information is determined without usage of feedback from the DUT 14.

Generally, the DUT 14 may estimate channel state information (CSI) by itself and transmit the estimated CSI 18 to the radio communication tester 12, as illustrated in FIG. 1. Additionally or alternatively, the DUT 14 may perform a CSI measurement. The measured CSI 20 may be transmitted to the radio communication tester 12. For example, the measured CSI 20 may be compressed by the DUT 14 and transmitted to the radio communication tester 12 in compressed form, where it is subsequently decompressed.

The CSI 20 may be processed and evaluated by the radio communication tester 12 so as to provide a CSI metric evaluation 22, the result of which can be outputted to a user 24. Consequently, an intervention of the DUT 14 is required by the method according to the state of the art.

In contrast to the state of the art, the disclosed subject matter provides that the CSI is determined without usage of feedback from the DUT 14, namely without any intervention of the DUT 14. Accordingly, neither CSI estimated by the DUT 14 nor CSI measured by the DUT 14 are necessary for determining the CSI. In an embodiment, CSI is determined by the radio communication tester 12 itself. Accordingly, CSI can be provided in a timely and efficient manner. Nonetheless, the determined CSI may optionally be compared with CSI reported by the DUT 14.

Hereinafter, three different concepts are described in more detail how the CSI can be determined.

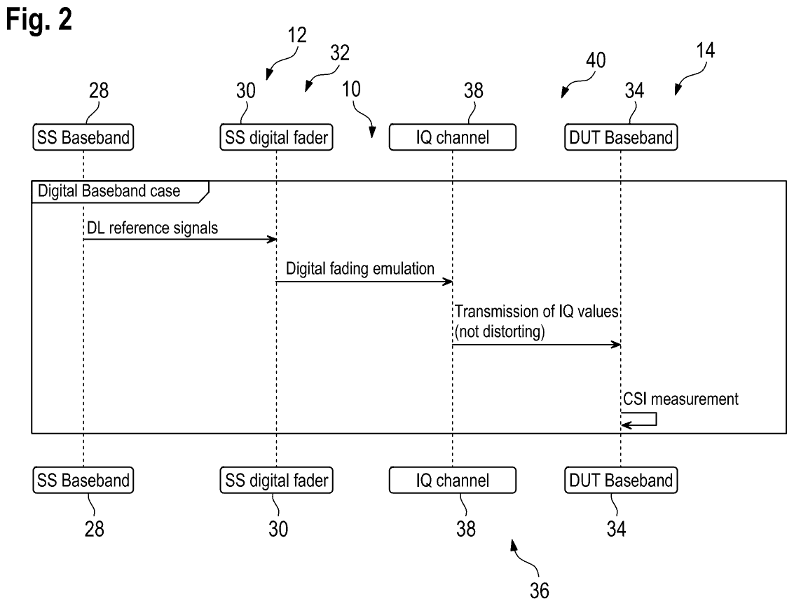

As illustrated in FIG. 2, the radio communication tester 12 has a baseband circuit 28 and a digital fader 30 which together with the baseband circuit 28 establishes a digital part 32 of the radio communication tester 12. In an embodiment, the DUT 14 has a baseband circuit 34 as well. The radio communication tester 12 and the DUT 14 communicate directly in a baseband 36 during the testing of the device under test 12, namely via an IQ channel 38.

The components involved, namely the baseband circuit 28 of the radio communication tester 12, the digital fader 30 of the radio communication tester 12, the IQ channel 38 and the baseband circuit 34 of the DUT 14, relate to a signal chain 40 between the radio communication tester 12 and the device under test 14. As indicated above, any analog part of the radio communication tester 12 and the device under test 14 is bypassed. Hence, baseband signal processing and signaling can be tested.

In an embodiment, downlink reference signals provided by the baseband circuit 28 of the radio communication tester 12 can be processed for example by the digital fader 30 of the radio communication tester 12 so as to generate IQ values that are transmitted via the IQ channel 38 to the baseband circuit 34 of the DUT 14.

In an embodiment, a channel emulator (if present) or the digital fader 30 just needs to report the generated channel coefficients, e.g. the fading coefficients, in order to enable the radio communication tester 12 to determine the CSI.

In general, emulation parameters (or emulation/channel coefficients) of the radio communication tester 12 may be used for determining the CSI. The emulation parameters (emulation/channel coefficients) may comprise, for example, the fading parameters (fading coefficients) used by the digital fader 26 of the radio communication tester 12. In an embodiment, varying fading parameters may be considered for determining the CSI as well.

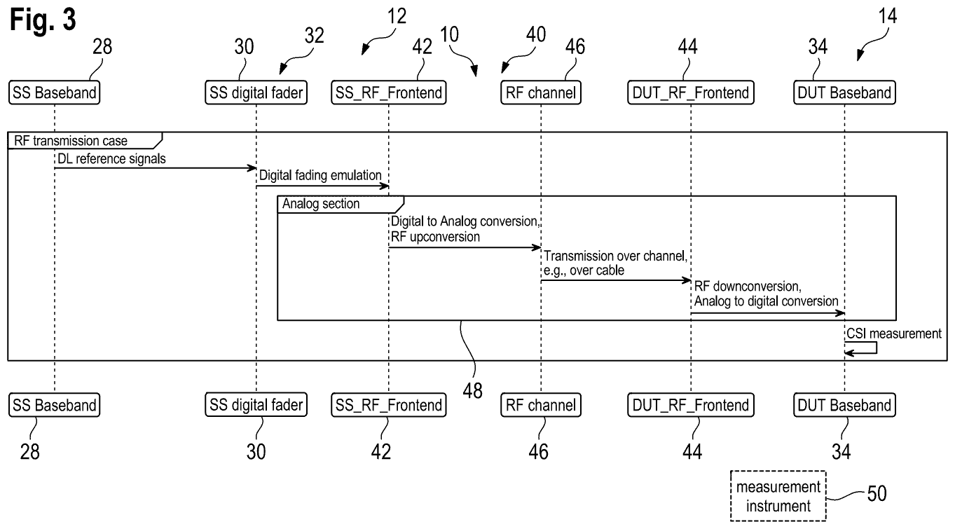

In FIG. 3, another example is depicted where the radio communication tester 12 and the DUT 14 communicate via their respective RF front ends 42, 44. Accordingly, additional components are involved in the signal chain 40, namely the front end 42 of the radio communication tester 12, a transmission channel 46 between the radio communication tester 12 and the DUT 14, and the front end 44 of the DUT 14.

Hence, analog components, establishing an analog part/section 48, are involved in addition to the digital components already described with respect to FIG. 2, e.g., the digital part/section 32, namely the baseband circuit 28 of the radio communication tester 12, the digital fader 30 of the radio communication tester 12 and the baseband circuit 34 of the DUT 14. The IQ channel 38 shown in FIG. 2 is however replaced by the transmission channel 46 established between the analog front ends 42, 44. Actually, the transmission channel 46 can be e.g. a radio channel, e.g. an over-the-air channel, or a transmission line.

In this example, front end parameters and transmission channel parameters were determined previously. The front end parameters may comprise the RF front end parameters of the RF front end 42 of the radio communication tester 12 as well as the RF front end parameters of the RF front end 44 of the DUT 14.

Generally, the front end parameters and the transmission channel parameters are used for determining the CSI. Of course, emulation parameters as described above with regard to FIG. 2 may also be used for determining the CSI as well, namely the parameters associated with the digital part/section 32, for example the digital fader 30.

Since analog and digital components are involved in the signal chain 40, the CSI may be determined by forming a convolution that uses the emulation parameters, the front end parameters, and the transmission channel parameters. Specifically, the convolution uses the emulation parameters, the RF front end parameters of the RF front end 42 of the radio communication tester 12, the transmission channel parameters, and the RF front end parameters of the RF front end 44 of the DUT 14.

This is based on the realization that the end-to-end channel is a composition of the respective channel components of the signal chain 40. Therefore, the channel components have to be concatenated. If all channel components are linear (or modelled as such), the concatenation is equivalent to a convolution. The analog components, i.e. the RF front ends 42, 44 and the transmission channel 46, can be convolved offline. The contribution of the digital part/section 32 can be evaluated at runtime of the testing procedure and added at each channel realization. Accordingly, the CSI can be provided without cooperation at runtime from the DUT 14.

As indicated above, the front end parameters concern the RF front end 42 of the radio communication tester 12 and the RF front end 44 of the DUT 14, respectively. The transmission channel parameters concern a radio channel or a transmission line provided between the RF front end 42 of the radio communication tester 12 and the RF front end 44 of the DUT 14.

The front end parameters of the RF front end 42 of the radio communication tester 12, the front end parameters of the RF front end 44 of the DUT 14 and/or the transmission channel parameters were measured with a measurement instrument 50 distinct from the radio communication tester 12, as schematically illustrated in FIG. 3.

As an example, the front end parameters of the RF front end 44 of the DUT 14 may have been measured previously by a manufacturer of the DUT 14, a customer or an application engineer at a customer site. As another example, the front end parameters of the RF front end 42 of the radio communication tester 12 may have been carried out when manufacturing the radio communication tester 12 or during its maintenance.

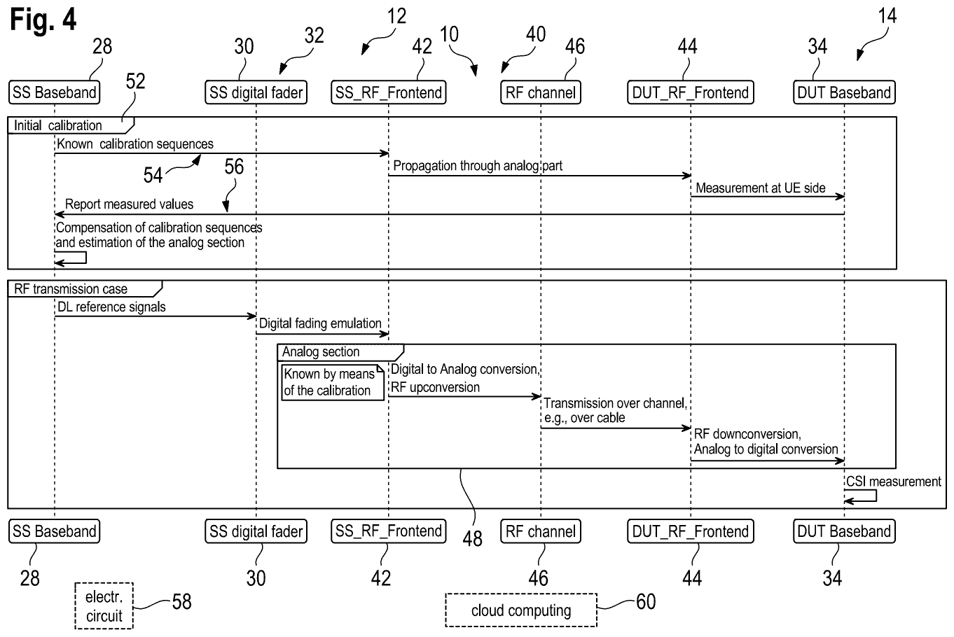

FIG. 4 relates to an aspect where calibration parameters (calibration values) are inter alia used for determining the CSI. In an embodiment, the calibration parameters may be used in addition to emulation parameters (emulation coefficients) of the radio communication tester 12. The calibration parameters can be obtained by performing an initial calibration 52 before the testing of the DUT 14.

In an embodiment, the calibration parameters (calibration values) concern a composition comprising the RF front end 42 of the radio communication tester 12, the RF front end 44 of the DUT 14, as well as the radio frequency channel 46, e.g. a wireless connection or a transmission line, provided between the RF front end 42 of the radio communication tester 12 and the RF front end 44 of the DUT 14.

In an embodiment, the calibration 52 may comprise transmitting calibration sequences 54 from the radio communication tester 12 to the DUT 14 via the radio frequency channel 46, and transmitting a response 56 to the calibration sequences 54 from the DUT 14 to the radio communication tester 12, which encompass measured values.

The radio communication tester 12 can estimate the impact of the analog part/section 48, i.e. the RF front ends 42, 44 and the transmission channel 46, from the response 56 to the calibration sequences 44, namely the measured values.

The RF front end 42 of the radio communication tester 12, the RF front end 44 of the DUT 14, as well as a transmission channel 46 may maintain constant properties during the testing of the DUT 14 afterwards. In this case, only one measurement is required for these analog components of the signal chain 40. Hence, it is only necessary to determine the impact of the digital part/section 32 during testing the DUT 14, as described with regard to FIG. 2, as the impact of the analog part/section 48 maintains constant and was determined in course of the initial calibration 52 previously.

Generally, the front end parameters of the RF front end 42 of the DUT 14 may be based e.g. on a reference signal received power (RSRP) report. The RSRP report may comprise information about a reference signal received power per branch concerning the radio communication tester 12 as well as a reference signal antenna relative phase concerning the radio communication tester 12.

In an embodiment, the CSI may be determined, for example, by an electronic circuit 58 of the radio communication tester 12 as schematically illustrated in FIG. 4. As another example, the CSI may be determined by a cloud computing circuit 60 that is separately formed with respect to the radio communication tester 12, as also schematically illustrated in FIG. 4.

In an embodiment, the determined CSI may be compared with reported CSI that was obtained from the DUT 14. The determined CSI may be compared for example with a reported CSI that was measured or estimated by the DUT 14 as illustrated in FIGS. 2 to 4 by the “CSI measurements”. Additionally or alternatively, the determined CSI may be compared with a predefined threshold.

For comparing the determined CSI with the reported CSI, a similarity metric 22, for instance a generalized squared cosine similarity (GSCS), may be calculated. The GSCS can be understood as a cosine similarity where the cosine value is squared. Subsequently, the calculated similarity metric 22 may be provided to a user 24.

Certain embodiments disclosed herein include systems, apparatus, modules, units, devices, components, etc., that utilize circuitry (e.g., one or more circuits) in order to implement standards, protocols, methodologies or technologies disclosed herein, operably couple two or more components, generate information, process information, analyze information, generate signals, encode/decode signals, convert signals, transmit and/or receive signals, control other devices, etc. Circuitry of any type can be used. It will be appreciated that the term “information” can be use synonymously with the term “signals” in this paragraph. It will be further appreciated that the terms “circuitry,” “circuit,” “one or more circuits,”etc., can be used synonymously herein.

In an embodiment, circuitry includes, among other things, one or more computing devices such as a processor (e.g., a microprocessor), a central processing unit (CPU), a graphics processing unit (GPU), a digital signal processor (DSP), an application-specific integrated circuit (ASIC), a field programmable gate array (FPGA), a system on a chip (SoC), or the like, or any combinations thereof, and can include discrete digital or analog circuit elements or electronics, or combinations thereof. In an embodiment, circuitry includes hardware circuit implementations (e.g., implementations in analog circuitry, implementations in digital circuitry, and the like, and combinations thereof).

In an embodiment, circuitry includes combinations of circuits and computer program products having software or firmware instructions stored on one or more computer readable memories that work together to cause a device to perform one or more protocols, methodologies or technologies described herein. In an embodiment, circuitry includes circuits, such as, for example, microprocessors or portions of microprocessor, that require software, firmware, and the like for operation. In an embodiment, circuitry includes an implementation comprising one or more processors or portions thereof and accompanying software, firmware, hardware, and the like.

For example, the functionality described herein can be implemented by special purpose hardware-based computer systems or circuits, etc., or combinations of special purpose hardware and computer instructions. Each of these special purpose hardware-based computer systems or circuits, etc., or combinations of special purpose hardware circuits and computer instructions form specifically configured circuits, machines, apparatus, devices, etc., capable of implementing the functionality described herein.

Of course, in an embodiment, two or more of these components, or parts thereof, can be integrated or share hardware and/or software, circuitry, etc. In an embodiment, these components, or parts thereof, may be grouped in a single location or distributed over a wide area. In circumstances where the components are distributed, the components are accessible to each other via communication links.

In an embodiment, one or more of the components, such as the radio communication tester 12 and the DUT 14 of FIGS. 2-4, the measurement instrument 50, the electronic circuit 58, the cloud computing circuit 60, etc., referenced above include circuitry programmed to carry out one or more steps of any of the methods disclosed herein. In an embodiment, one or more computer-readable media associated with or accessible by such circuitry contains computer readable instructions embodied thereon that, when executed by such circuitry, cause the component or circuity to perform one or more steps of any of the methods disclosed herein.

In an embodiment, the computer readable instructions includes applications, programs, program modules, scripts, source code, program code, object code, byte code, compiled code, interpreted code, machine code, executable instructions, and/or the like (also referred to herein as executable instructions, instructions for execution, program code, computer program instructions, and/or similar terms used herein interchangeably).

In an embodiment, computer-readable media is any medium that stores computer readable instructions, or other information non-transitorily and is directly or indirectly accessible by a computing device, such as processor circuitry, etc., or other circuity disclosed herein etc. In other words, a computer-readable medium is a non-transitory memory at which one or more computing devices can access instructions, codes, data, or other information. As a non-limiting example, a computer-readable medium may include a volatile random access memory (RAM), a persistent data store such as a hard disk drive or a solid-state drive, or a combination thereof. In an embodiment, memory can be integrated with a processor, separate from a processor, or external to a computing system.

Accordingly, blocks of the block diagrams and/or flowchart illustrations support various combinations for performing the specified functions, combinations of operations for performing the specified functions and program instructions for performing the specified functions. These computer program instructions may be loaded onto one or more computer or computing devices, such as special purpose computer(s) or computing device(s) or other programmable data processing apparatus(es) to produce a specifically-configured machine, such that the instructions which execute on one or more computer or computing devices or other programmable data processing apparatus implement the functions specified in the flowchart block or blocks and/or carry out the methods described herein. Again, it should also be understood that each block of the block diagrams and flowchart illustrations, and combinations of blocks in the block diagrams and/or flowchart illustrations, or portions thereof, could be implemented by special purpose hardware-based computer systems or circuits, etc., that perform the specified functions or operations, or combinations of special purpose hardware and computer instructions.

It will be appreciated that in one or more embodiments, the term computer or computing device can include, for example, any computing device or processing structure, including but not limited to a processor (e.g., a microprocessor), a central processing unit (CPU), a digital signal processor (DSP), an application-specific integrated circuit (ASIC), a field-programmable gate array (FPGA), a system on a chip (SoC), a graphics processing unit (GPU) or the like, or any combinations thereof.

In the foregoing description, specific details are set forth to provide a thorough understanding of representative embodiments of the present disclosure. It will be apparent to one skilled in the art, however, that the embodiments disclosed herein may be practiced without embodying all of the specific details. In some instances, well-known process steps have not been described in detail in order not to unnecessarily obscure various aspects of the present disclosure.

Although the method and various embodiments thereof have been described as performing sequential steps, the claimed subject matter is not intended to be so limited. As nonlimiting examples, the described steps need not be performed in the described sequence and/or not all steps are required to perform the method. Moreover, embodiments are contemplated in which various steps are performed in parallel, in series, and/or a combination thereof. As such, one of ordinary skill will appreciate that such examples are within the scope of the claimed embodiments.

In the detailed description herein, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. In addition, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments. Thus, it will be appreciated that embodiments of the present disclosure may employ any combination of features described herein. All such combinations or sub-combinations of features are within the scope of the present disclosure.

Throughout this specification, terms of art may be used. These terms are to take on their ordinary meaning in the art from which they come, unless specifically defined herein or the context of their use would clearly suggest otherwise.

The drawings in the FIGURES are not to scale. Similar elements are generally denoted by similar references in the FIGURES. For the purposes of this disclosure, the same or similar elements may bear the same references. Furthermore, the presence of reference numbers or letters in the drawings cannot be considered limiting, even when such numbers or letters are indicated in the claims.

The present application may reference quantities and numbers. Unless specifically stated, such quantities and numbers are not to be considered restrictive, but exemplary of the possible quantities or numbers associated with the present application. Also in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 5% of the stated value. For the purposes of the present disclosure, the phrase “at least one of A and B” is equivalent to “A and/or B” or vice versa, namely “A” alone, “B” alone or “A and B.”. Similarly, the phrase “at least one of A, B, and C,” for example, means (A), (B), (C), (A and B), (A and C), (B and C), or (A, B, and C), including all further possible permutations when greater than three elements are listed.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

The embodiments of the invention in which an exclusive property or privilege is claimed are defined as follows:

1. A method for evaluating downlink characteristics in an emulated cellular network provided by a radio communication tester for testing a device under test, the method comprising:
connecting the radio communication tester with the device under test via the network, thereby establishing a downlink channel for the device under test;
determining at least one channel state information of the downlink channel while testing the device under test, wherein said determining the channel state information occurs without usage of a feedback from the device under test.

2. The method according to claim 1, further comprising establishing a signal chain between the radio communication tester and the device under test, wherein parameters of components involved in the signal chain are used for determining the channel state information.

3. The method according to claim 2, wherein the components involved in the signal chain comprise a front end of the radio communication tester, a transmission channel between the radio communication tester and the device under test, and a front end of the device under test.

4. The method according to claim 3, wherein the components involved in the signal chain also comprise a digital fader of the radio communication tester.

5. The method according to claim 1, wherein emulation parameters of the radio communication tester are used for determining the channel state information.

6. The method according to claim 5, wherein the emulation parameters comprise fading parameters used by a digital fader of the radio communication tester.

7. The method according to claim 1, wherein the radio communication tester and the device under test communicate directly in a baseband during the testing.

8. The method according to claim 1, further comprising determining front end parameters and transmission channel parameters previously, wherein the front end parameters and the transmission channel parameters are used for determining the channel state information, wherein the front end parameters concern a radio frequency, RF, front end of the radio communication tester and a radio frequency, RF, front end of the device under test, respectively, and wherein the transmission channel parameters concern a radio channel or a transmission line provided between the RF front end of the radio communication tester and the RF front end of the device under test.

9. The method according to claim 8, wherein the channel state information is determined by forming a convolution that uses the emulation parameters, the front end parameters, and the transmission channel parameters.

10. The method according to claim 8, further comprising measuring at least one of the front end parameters of the RF front end of the radio communication tester, the front end parameters of the RF front end of the device under test, or the transmission channel parameters with a measurement instrument distinct from the radio communication tester.

11. The method according to claim 8, wherein the front end parameters of the RF front end of the device under test were measured previously by a customer or an application engineer at a customer site.

12. The method according to claim 8, wherein the front end parameters of the RF front end of the device under test are based on a reference signal received power report.

13. The method according to claim 12, wherein the reference signal received power report comprises information about a reference signal received power per branch concerning the radio communication tester as well as a reference signal antenna relative phase concerning the radio communication tester.

14. The method according to claim 1, further comprising considering varying fading parameters for determining the channel state information.

15. The method according to claim 1, wherein additional calibration parameters are used for determining the channel state information, wherein the calibration parameters are obtained by performing a calibration before the testing of the device under test, wherein the calibration parameters concern a composition comprising a radio frequency, RF, front end of the radio communication tester and a radio frequency, RF, front end of the device under test, respectively, as well as a radio channel or a transmission line provided between the RF front end of the radio communication tester and the RF front end of the device under test.

16. The method according to claim 15, wherein the calibration comprises transmitting a calibration sequence from the radio communication tester to the device under test via the radio channel or transmission line, and transmitting a response to the calibration sequence from the device under test to the radio communication tester.

17. The method according to claim 1, wherein a radio frequency, RF, front end of the radio communication tester and a radio frequency, RF, front end of the device under test, respectively, as well as a transmission channel provided between the RF front end of the radio communication tester and the RF front end of the device under test maintain constant properties during the testing.

18. The method according to claim 1, wherein the channel state information is determined by an electronic circuit of the radio communication tester.

19. The method according to claim 1, wherein the channel state information is determined by a cloud computing circuit that is separately formed with respect to the radio communication tester.

20. The method according to claim 1, wherein the determined channel state information is compared with reported channel state information that was obtained from the device under test.
